(19) United States
(12) Patent Application Publication
(10) Pub. No.: US 2016/0363950 A1
(43) Pub. Date: Dec. 15, 2016

(54) RESOURCE MANAGEMENT FOR OPTIMIZED GRID OPERATIONS

(71) Applicant: Innovari, Inc., Hillsboro, OR (US)

(72) Inventors: Loran Friedrich, Portland, OR (US); David Walden, Austin, TX (US); Chris Hickman, Lone Tree, CO (US); Robin Jensen Lunt, Parker, CO (US); Jason Hill, Portland, OR (US); Eric Pierce, Portland, OR (US); Nathan Ronald Ortega, Lake Oswego, OR (US); Phong Do, Austin, TX (US); James Tillett, Portland, OR (US)

(21) Appl. No.: 15/182,280

(22) Filed: Jun. 14, 2016

Related U.S. Application Data
(60) Provisional application No. 62/175,743, filed on Jun. 15, 2015.

(51) Int. Cl. G05F 1/66; G05B 15/02

(52) U.S. Cl. CPC G05F 1/66; G05B 15/02

(57) ABSTRACT

The subject matter described herein relates to the organized measurement, dispatch and/or control of disparate and distributed resources along the length of and at the ends of the electrical grid. Related systems, apparatus, methods, and articles are also described.

### RELATED APPLICATIONS

This application claims priority under 35 U.S.C. §119 to U.S. Provisional Patent Ser. No. 62/175,743, filed on Jun. 15, 2015, and titled “Resource Management for Optimized Grid Operations,” the entire contents of which are hereby incorporated by reference. Related U.S. application Ser. No. 13/803,816 filed Mar. 14, 2013, is hereby expressly incorporated by reference herein. U.S. application Ser. No. 13/803,816 claims priority to U.S. Provisional Application No. 61/640,318, filed on Apr. 30, 2012, which is hereby expressly incorporated by reference.

### TECHNICAL FIELD

The subject matter described herein relates to the organized measurement, dispatch and control of many disparate and distributed resources along the length of and at the ends of the electrical grid.

### BACKGROUND

The total load and/or impact of distributed resources connected to a power grid can vary significantly over time. The total load can be the sum of individual choices by many consumers at any instant in time, which if altered, result in a net change of reduced energy consumption or increased energy consumption on the grid.

The net change, in a positive or negative direction, of loads when controlled by an operating system as described herein can be considered a “resource” in that the response to control requests can change the electrical flow on the grid to improve on the interests of a grid operator. The impact of distributed resources includes all nature of distributed generation systems (such as the generation of, or lack of generation by intermittent solar PV arrays), energy storage systems which can consume and deliver power, utility equipment which supports the operation of the grid (such as capacitor banks and voltage regulators), equipment that may impact individual electrical phases asymmetrically and many other elements. The result is dynamic and sometimes rapidly varying energy delivery pattern which must be served by balancing and integrating the increasing number of distributed supplies and demands (together described as resources) through management of these resources along the electrical grid.

### SUMMARY

The subject matter described herein relates to the organized measurement, dispatch and control of many disparate and distributed resources along the length of and at the ends of the electrical grid, including on customer premises, and including those with impacts on individual phases of the electrical grid, together combined as “resource management”, including the generation, storage or consumption of, and its relationship to, the optimized delivery of power across an electrical grid. Some aspects include operating and dispatching operating algorithms; electrical grid power flow analysis and modeling; forecasting of consumption; resource organization; and interfacing with a requesting party such as a utility; market participant or others for enabling grid optimization; system balancing; reduced system losses and other services.

In one aspect, data comprising a request specifying a desired operating profile or target objective for the desired electrical characteristics such as real power (P), reactive power (Q), volts (V), amps (I), and the V/I phase angle (θ), of any individual resource, and the coordination of all resources located along the electrical grid is received. The electrical flow across the grid is associated with, and can be moderated with a plurality of resources under control of resource agents on a utility grid. The available capacity (energy production or consumption) of any one or many resources within the control of each resource agent is determined. With monitoring, communication, analysis, estimating, forecasting and other decision metrics, resource operating instructions are calculated for a subset of resources to solve for one or many simultaneous operating objectives. The resource operating instructions can be delivered to each resource agent for implementation of control and verification of desired results. Data characterizing the resource operating instructions is provided.

One or more of the following features can be included. For example, the data characterizing the resource control instructions can be provided to resource agents in control of their subset of resources. The request can be from a utility or other interested entity, or as a result of monitored signal criteria including the status of adjacent resources delivered by a peer-to-peer communication system. The instructed resource agents can be audited centrally or in relation to each other for actual capacity during the defined period of time and can be provided additional instructions to satisfy the desired change in electrical resource of the request. Determining available capacity can be further based on a set of deployment rules. The set of deployment rules can include one or more of: a set of operating parameters to be maintained, a target or threshold set-point or objective to be met, a duration or bandwidth to maintain an instruction, and any combination of logic processing to be managed by the resource agent(s). The set of deployment rules can also reflect terms that a resource manager has previously agreed to.

Resources can be any combination of loads, generation sources, energy or thermal storage systems, or other equipment which may impact or support the operation of the electrical grid such as capacitor banks or voltage regulators, or others. An operating model can be created and dynamically updated based on data describing a state and electrical capacity or impact of each resource. Each resource can also be modeled based on past observations of the same or a similar resource. All models described herein can be one of linear, non-linear, or stepwise discontinuous and include extraneous data such as weather data, planned maintenance or non-operation, and others.

Feedback can be received from one or more of the resource agent(s), a resource, a set of resources, or a user. The calculation of the subset of resources and resource operating instructions can be based on the received feedback. Providing data can include one of persisting, displaying, and transmitting.

Described herein are operating algorithms, electrical power-flow modeling, forecasting of supply and consumption, resource organization and interfacing with utilities and other interested parties for enabling grid resource control to optimize overall grid utilization including phase specific operation of resources along a three-phase electrical grid. All of these efforts lead to overall grid optimization through the provision of a variety of services. The process of controlling consumption as an alternative to, and in conjunction with, generation and energy storage is herein referred to as resource management. Additionally, resource management includes any desired effects for grid optimization, improved grid efficiency or other purposes such as phase balancing and voltage control. Resource management also enables a requesting party such as a utility, market participant or others to engage in cost effective decisions when purchasing or managing a power portfolio or operating the grid. Resource management may be governed by a set of deployment rules, decision trees, or other means of criteria which may be arranged in a table, list, formula, matrix or array, herein called the deployment rule matrix. For example when a request for action is received from a requesting party, a resource processor, using multiple inputs and data sources, determines with algorithms, rules or calculations an available resource capacity and additional analysis such as forecasting. The resource processor may automatically or by operator instructions generate resource instructions to control any combination of resources to satisfy the requirements of the request.

In another aspect, data can include a request specifying a desired change in electrical activity of a controlled resource for the purpose of grid optimization. The electrical operating state is associated with a plurality of resources under control of resource agents on a utility grid and including resources on end-use customer premises. Available capacity of resources within the control of each resource agent over the defined period of time is determined. Each available capacity is determined at least using a resource capacity or contribution model. Using the determined available capacity of resources over the defined period of time, resource operating instructions are calculated for any subset of resources. The resource operating instructions satisfy the desired change in electrical contribution of each individual resource to meet the aggregate request. Data characterizing the resource operating instructions is provided.

In another aspect, the current subject matter can include a combination of centralized system, end-points, cloud, processing, and the like including components of centralized control; components of distributed processing or control; components of communications including networked, point to point, and peer-to-peer; components of autonomous operating allowances; components of arbitration between multiple control requests; components of measurement and verification of control actions; and components of the hierarchical relationship between resources, including electrical characteristics of real and reactive power flow.

In another aspect, the current subject matter can include systems for the adaptive power management, P&Q along the entire length of feeder; components of Voltage; components of real and imaginary power flow; components of phase balancing; and components of electrical losses and/or improved utilization and operating efficiency.

In another aspect, the current subject matter can include systems for power management along a feeder utilizing site resources directed at supporting the grid requirements rather than only the site requirements. Extending such that the instruction provided to a resource at a site may be sub-optimal for that site, yet, in consideration of the entire grid may improve the operation for which the system improvement outweighs the local impact at the site of the resource.

In another aspect, the current subject matter can include systems to aggregate a plurality of resources at a plurality of locations along an electrical grid in an organized manner to result in an improvement of operation of the serving grid as a global resource.

In another aspect, the current subject matter can include systems to coordinate power management actions between a plurality of resources at a plurality of locations along an electrical grid including decision making algorithms; timely; auditing of control requests, resulting actions and issuing corrective actions; grid level reliability and security; and forecast and prediction of resource capacity, operating parameters, combined impact of multiple resources.

In another aspect, the current subject matter can include systems to monitor and control real and reactive power flow along a feeder within the physical or operating limitations of the resources, including the organization and employment of other resources which may have overlapping impact or together in a multiple of configurations may provide desired results.

In another aspect, the current subject matter can include systems to monitor and control as an aggregate any combination of a plurality side of resources in consideration of each resource effect on the site (local) as well as the effect of each resource, or combined resources on the grid (global).

In another aspect, the current subject matter can include system to forecast the future need for real and reactive power flow along a feeder and the future contribution of potential resources.

In another aspect, the current subject matter can include systems to solve for optimal configuration of aspects described herein.

In another aspect, the current subject matter can include systems of combining and controlling multiple resources at a common location; the ideal configuration and all parts under control by the system; definition of resources; and definition of metering or sensing.

In another aspect, the current subject matter can include receiving, by the one or more data processors, data indicating discrepancies between expected and actual change in the electrical contribution of a resource (as a load or a generation source and by electrical phase). The current subject matter can further include calculating, the expected change in impact of the resource on the desired operating solution based on any operating instruction. The current subject matter can further include processing, when the discrepancies between expected and actual resource performance exceeds a predetermined magnitude. The current subject matter can further include delivering an operating instruction specifying a desired change in electrical contribution of one or many resources according to some aspects described herein. The current subject matter can further include providing, using the one or more data processors, data characterizing the second resource operating instruction.

One or more of the following features can be included in any feasible combination. For example, the data characterizing the resource operating instruction can be provided to a plurality of different resource agents in control of one or more respective resources. The current subject matter can further include providing, using the one or more data processors, the data indicating discrepancies between expected and actual change in electrical contribution of the resource. The current subject matter can further include determining, using the one or more data processors, available capacity of a plurality of different resources within control of different respective resource agents over a defined period of time by accessing at least one data source comprising predefined parameterized capacity models. Providing data can include one of persisting, displaying, and transmitting.

In another aspect, the current subject matter can include receiving, by the one or more data processors, data indicating discrepancies between expected and actual change in electrical contribution of each of a plurality of resources. The expected change in electrical contribution based on a first resource operating instruction corresponding to the resource. The current subject matter can further include calculating, using the received data and the one or more data processors, an aggregate lost capacity envelope across all of the resources. The current subject matter can further include providing, by the one or more data processors, the aggregate lost capacity envelope. The current subject matter can further include processing, when the discrepancies between expected and actual resource performance exceeds a predetermined magnitude, a second resource operating instruction specifying a desired change in electrical contribution according to the lost capacity envelope.

One or more of the following features can be included in any feasible combination. For example, the current subject matter can further include determining, using the one or more data processors, available capacity of a plurality of different resources within control of different respective resource agents over a defined period of time by accessing at least one data source comprising predefined parameterized capacity models. The deployment rule includes one or more of: a duration a given resource may be dispatched, a rest period of a given resource, and one or more operational constraints on a given resource.

Articles of manufacture are also described that comprise computer executable instructions permanently stored (e.g., non-transitorily stored, etc.) on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. In addition, methods can be implemented by one or more data processors either within a single computing system or distributed among two or more computing systems.

The details of one or more variations of the subject matter described herein are set forth in the accompanying drawings and the description below. Other features and advantages of the subject matter described herein will be apparent from and included by implication to the description and drawings, and from the claims.

### DESCRIPTION OF DRAWINGS

FIG. 1 is a schematic illustrating an example overview of the components of the central processing platform (however, is not an exhaustive listing of potential components) and its interaction with resources agents deployed along the electrical grid and operators or requesting parties. Other variations can be utilized for the same.

FIG. 2 is a schematic illustrating an example overview of the components (however, is not an exhaustive listing of potential components) contributing to the process of resource management enabling grid resource control to optimize overall grid utilization including phase specific operations. Other variations can be utilized for the same.

FIG. 3 is a schematic illustrating an example deployment of grid power balancing resources along the components of the utility distribution infrastructure both logically and physically located along any portion of an electrical grid, such as a distribution feeder. Lines of communication are demonstrated between each control unit and a central processing platform as well as peer to peer communications between control units. Other variations can be utilized for the same.

FIG. 4 describes the localized effect grid power balancing resources or combined resources have on the power imbalance of an electrical grid, such as along a distribution feeder. The schematic demonstrates a determined interaction and relationship between resources on the feeder extending from the electrical characteristics of each resource, which may not be symmetric to any individual phase of the three-phase electrical grid, and how proximity affects are important for dense deployments.

FIG. 5 is a process flow diagram illustrating a method of collecting and analyzing characterization data and providing resource operating instructions. The basic sequence described may also be iterative and include optional solutions.

FIG. 6 is a process flow diagram illustrating a method of autonomous operation of grid power balancing systems with peer to peer communication of state and configuration. The basic sequence described may also be iterative, include limitations or other operating constraints as delivered by the central processing platform for which the individual resources may then optimize local operation in an autonomous or peer-to-peer relationship.

### DETAILED DESCRIPTION

Rather than only managing the input of power to and electrical loads on the grid, it can be beneficial to manage many, if not all resources on the grid, regardless of their distributed locations, with the specificity of individual phases along the grid in order to reduce the losses and improve the efficiency, reliability, economics, and sustainability of electricity services. By managing these grid edge resources through a combination of centralized and peer interactive means these benefits can be enabled.

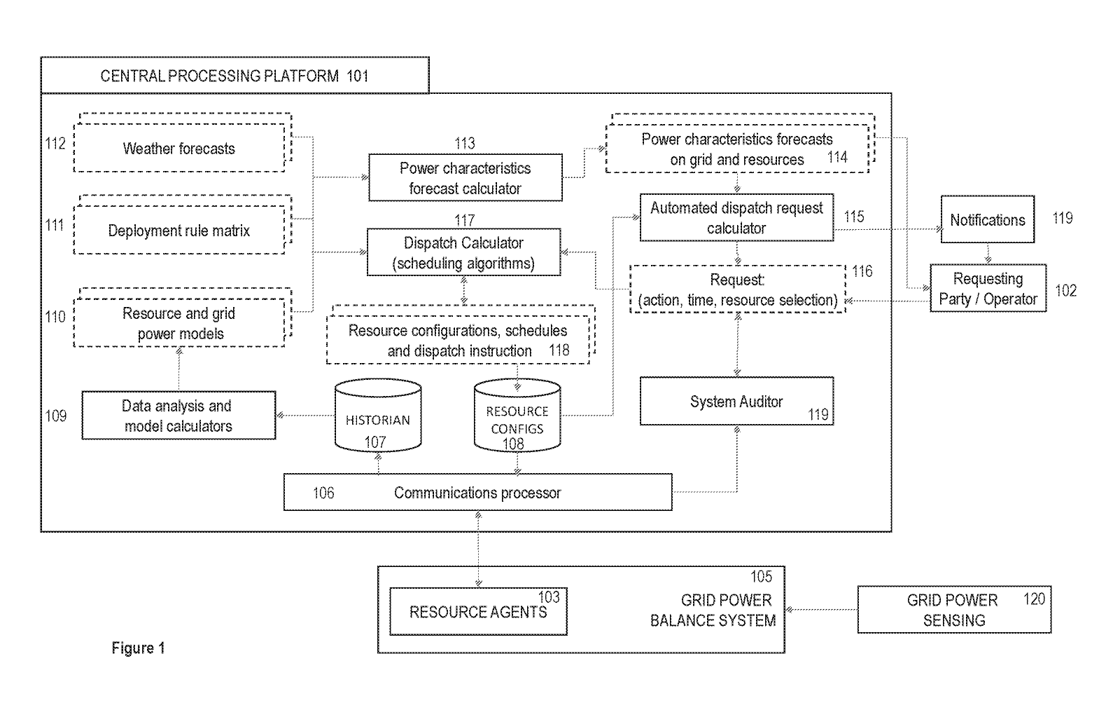

FIG. 1 is a schematic overview 100 of the central processing platform 101 comprised of the components for the process of engaging resources to satisfy grid power optimization requests. Resource agents 103 are deployed along physical locations of the electrical grid and control one or many of a plurality of resource and sensing equipment which in turn are used to manage power on the electrical grid using any combination of components, together described as a Grid Power Balance System (GPBS) 105 to enable direct control over loads, generation sources or energy storage systems, collectively “resources” and variable contributions to the grid power in the form of P, Q, V, I and θ. The resource agents 103 send and receive data with the central processing platform 101, or possibly other resource agents directly, through two-way communications processors 106 on predetermined and configurable intervals. The resource agents 103 send resource state and data characterizing the grid power from resources and systems under control of the GPBS 105. The characterizing data, resource state and resource agent 103 operation status is stored in a historical database 107 for subsequent access and analysis.

A data processor 109 performs analysis on the then present report of the Resource Agents 103, and any historical data characterizing the grid power as a function of time, weather, if in the case of a building, occupation, and many other parameters which may affect the operation of a resource as stored in the historian database 107. The data analysis processor continuously performs data modeling using a plurality of methodologies to create resource and grid power models 110 through various forms of representation and access.

The process of controlling the operation of resources to achieve grid optimization or other purposes such as phase balancing may be governed by a set of algorithms, deployment rules, decision trees, or other means of criteria which may be arranged in a table, list, formula, matrix or array, herein called the deployment rule matrix 111. Where a resource model 110 defines the operating instructions and the predictive state of a resource and resource configurations 108 describe a resource agent's 103 autonomous operation, physical location, and proximity with other resource agents, in particular the interaction between grid power balancing systems 105, a deployment rule defines the constraints on how the resource is dispatched.

Deployment rules may specify a number of constraints or operating parameters such as the duration of time the resource can be dispatched, any constraints during operations, sequence of operations, formulaic actions, or multiple other parameters. These rules are input to power characteristics forecast algorithms 113 and reflect upon the availability and type of resource dispatch therein. The rules also directly govern the dispatch calculator 117 and its generation of schedule dependent instructions.

Deployment rules include all aspects of the resource and can be dynamically updated by additional dispatch instructions, adjusted to coordinate with other peer-to-peer resources, and include all base parameters for operating autonomously as a matter of normal operation or in the case communication systems are compromised.

The rows of the deployment rule matrix may define a selectable product type and may be organized by impact on a consumer, the equipment premises, or any section of the electrical grid. The organization of the deployment rule matrix may be dynamic or predefined. The columns of the deployment rule matrix may define the time allotted to or allowable for dispatching those resources or any other operating constraint, including any permutations of conditions which may exist at the grid power balance system 105 upon receipt of a dispatch instruction, thus providing for if-then analysis and decision making by the resource agents 103. Deployment rules may be given a ranking which may increase with dispatch duration, resource selection, or both. The deployment rule matrix 111 may also reflect the terms and conditions of a contractual agreement with a consumer or resource operating constraints such as regulations on allowable generator run hours, charging and discharging schedules of power storage, and operational considerations of renewable power generation resources. The complete set of deployment rule matrices may be updated at any time, aggregated over many such premises and deployments to define overall resource availability and actionable grid power balancing tasks.

A process, the power characteristics forecast calculator 113, utilizes the resource and grid power models 110 in concert with resource deployment rules matrix 111 and weather forecasts 112 to generate power characteristics forecasts 114. The weather forecasts 112 may include any nature of operating parameters which may affect the resources, including any other environmental or operational parameters. The power characteristics forecasts detail the expected behavior of resources under control of the resource agent as part of the GPBS 105, and grid power flow 120 and the impact to the grid power as a function of resource agent dispatch action and duration as determined by resource type and functional capability. The requesting party 102 may also provide inputs to many of the described steps (such as a new deployment rule 111 or new resource definition 110) and select resources for analysis and view the forecasts 114 and when appropriate initiate a dispatch request 116.

A request generator 102 such as a utility or other entity knowing the total aggregated resources under control 103, issues a request 116, which may include phase specific instructions (such as desired contributions for P, Q, V, I and θ) which vary across multiple resources at a given time and duration to result in a combined effect on the electrical grid. A dispatch calculator receives the request 116 where algorithms generate unique instructions 118 to control one or many resources 105 that are available and under management of the entire system and as may be needed to satisfy the request. The dispatch calculator 117 processes the request, and may incorporate grid power models 110, deployment rules 111, weather forecasts 112 and resource agent configurations 108 including but not limited to physical location on the grid, to make decisions on dispatch actions and dispatch schedules represented by one or many dispatch instructions 118. It should be noted that the instructions 118 to any one resource agent 103 may not be reflective of the electrical conditions of the location of that resource, “the premises”, rather the required contribution to manage and optimize the entire electrical grid.

The dispatch calculator 117 may also receive a request 116 from an automated dispatch request calculator 115. This calculator processes power characteristics forecasts 114 and system resource agent 103 configurations 108 to make decisions on request generation. The automated process may also send alerts and notifications 119 to requesting parties 102 indicating the need for power balancing actions at a specified time with determined confidence levels. Final generation of the request 116 and submission to the central processing platform is configurable and may be from the requesting party 102 or automated request generator 115.

A dispatch request, having generated one or many unique instructions 118 to act upon resources in the GPBS 105 is audited by a system auditor process 119. This process compares the expected operation of GPBS resources 105 as detailed by schedule and instructions 118 to the present status, state and operation of the resources received from the communications processor 106. In the event of missed expectations, the system auditor can issue changes, such as acquiring additional resources or change to existing configurations, to the request 116 and send that to the dispatch calculator to issue revised or additional instructions 118. The system auditor ensures that the request 116 from either the requesting party 102 or automated dispatch calculator 115 has met its goals. The system auditor 119 may be responsible for the monitoring and modifying of resource instructions to achieve an overall balanced capacity to satisfy a request. During a request, many hundreds or thousands of GPBS resources 105 may be called upon to contribute. Events may occur that reduce the actual contribution made by any individual selected resource. For example, the discrepancy between actual capacity and predicted or forecast capacity due to weather related risks. As many GPBS resources 105 are dependent on physical properties like temperature, chemistry, and others, their contributions can vary, and when the resource agents 103 report the variance through communications 106, the system auditor 119 can determine corrective action or request action by any other element of the central processing platform to calculate, re-calculate or arbitrate between many inputs to deliver new or supplemental resource instructions 118 which are then used to satisfy the dispatch request 116. It may be the role of the system auditor 119 to ensure the requested dispatch 116 and actual grid power impacts are equal and consistent.

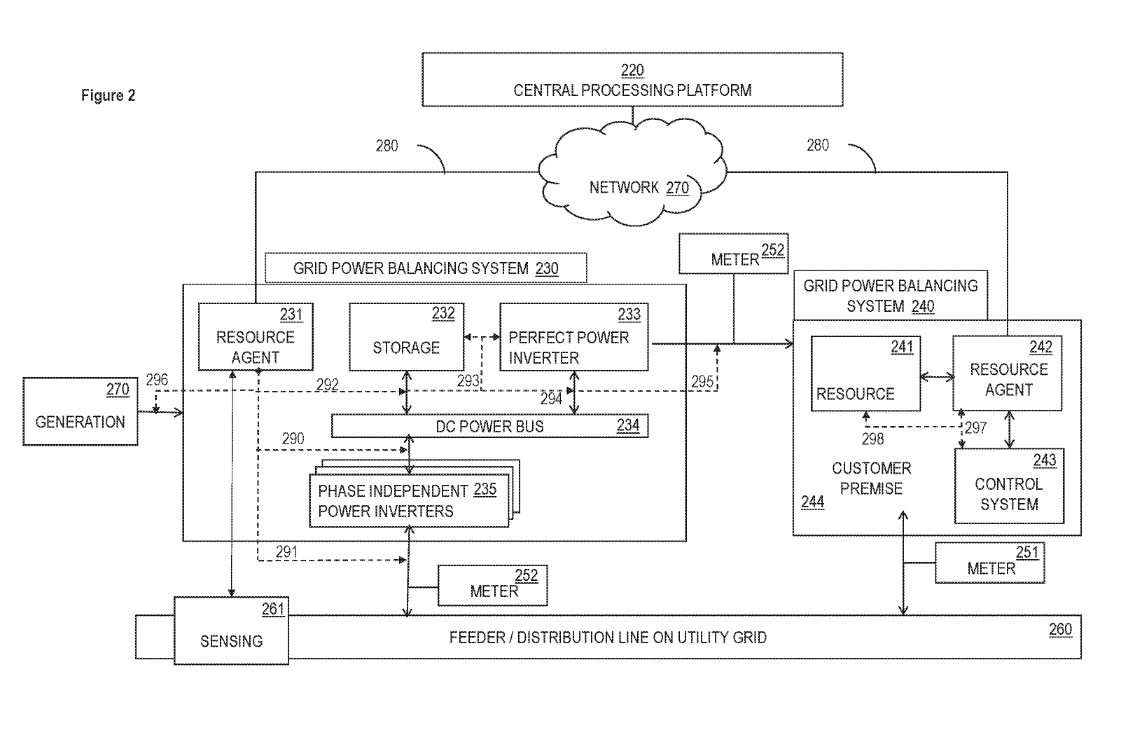

FIG. 2 is an illustration of the deployment of any combination of grid power balancing systems (GPBS) 230, 240 on a utility grid system, illustrated here as a distribution line or feeder 260. In one deployment 230, the GPBS is managing a plurality of resources including but not limited to power inverters (three phase 233 and single phase 235), storage components 232, DC power bus 234, power generation 270 (backup/standby generators or renewable generation such as photovoltaic or wind power generation) and grid sensing equipment 261. Interconnections of resources within a GPBS can include variations such as a DC-to-DC inverter when connecting photo-voltaic systems, an AC-to-AC inverter when connecting non-parallel equipment, and any configuration of electrical connection such as single phase, three phase, delta, wye, or other. This combined resource can be considered a single “system” 230 and can be directly connected to a feeder or other structure on the utility distribution line 260 with a dedicated power meter 252 measuring the flow of power into and out of the grid system as well as between GPBS control areas 230, 240, 260, 270 or others. In a second deployment 240, the GPBS is managing resources within a customer premises 244 either directly 241 or through a locally installed control system 243. The premises 244 may also be connected to the utility grid 260 and power is measured as is typical with the power meter 251.

Grid power balancing systems 230, 240 are controlled and managed by resource agents 231 and 242 which handle two-way communications 280 with the central processing platform 220 through the network 270. The resource agents 231, 241 furthermore delegate actions 292, 293, 294, 295, 296, 297, 298 governing the operation and interaction between a plurality of sub-systems 232, 233, 234, 235, 270, resources at customer premises 241, 243 and the utility grid 260 to enact grid power balancing actions locally and globally on a utility power grid 260. The resource agents 231, 242 can be configured in many forms and combined to manage local control either as a single resource agent over both grid power balancing systems 230, 240, or multiple resource agents within each example grid power balancing system. As for example, depending on operating convenience, a third resource agent may be applied to directly control the generation resource 270 through either local connection 296 or a new communication path 280.

Phase independent power inverters 235 may be connected to the grid distribution line 260 with power flow between the inverters and the utility grid measured by a meter or combination of meters 252. Real and reactive power flow through each phase of the phase independent inverter 235 is independently controlled and may flow through the inverter 235 to the power grid 260, adding real and reactive power to the grid, or may flow from the grid 260 through the inverter 235, drawing real and reactive power from the grid 260. The operational state of each single phase inverter 235 is set by the action requested 291 by the control unit 231. In this configuration, the combined resources of the grid power balancing system 230 can simultaneously draw real or reactive power on one phase and deliver real or reactive power to another phase on a typical three-phase utility grid, thereby balancing to total energy flow along the grid.

The DC Power Bus 234 provides a common medium that is free from constraints imposed by AC power, and such that power may flow within the GPBS to and from each of its enabled resources. The resources represented by DC Power Bus 234 in FIG. 2 are Generation 270, Storage 232, Perfect Power Inverter 233, and Phase Independent Power Inverters 235. Each of these resources connects to the DC Power Bus 234 at a common voltage and exchange power between each other in order to optimize operation of the utility power grid 260. This power exchange is coordinated and managed by the resource agent 231 and potentially further enabled by built-in resource control elements.

For example, the GPBS 230 may also support the deployment of storage capacity 232 to the utility power grid 260, and through the DC power bus 234, and the phase independent inverters 235. The storage sub-system 232 may be comprised of rechargeable batteries including but not limited to: lead-acid, nickel cadmium (NiCd), nickel metal hydride (NiMH), lithium-ion (Li-ion), and lithium ion polymer (Li-ion polymer), flow batteries, or flywheel batteries.

In another example, the GPBS 230 may also be deployed with power generation systems 270. Power generation, such as a diesel generator, may be on demand and requested via instruction 296. Renewable power generation including but not limited to photovoltaic and wind may be connected to the GPBS. The control unit 231 can route the generated power to the feeder 260, the customer premises 244 or to the storage system. 232.

The GPBS 230 may also use a perfect power inverter resource 233 supplying 3 phase power to a customer premises 244 to provide clean and reliable power to critical loads in the customer premises 244, and in some instances through a resource 241 that is controlled on-premises by the resource agent 242. The power supplied to the three phase power inverter 233 is managed by the resource agent 231 and can be from a plurality of storage configurations 232 or drawn from grid power 260 through the phase independent inverters 235. In this manner, the energy supplied to the customer premises can continue without interruption via energy storage 232 even in the event of a utility outage 260, and can further be extended with generation 270.

The GPBS 240 may control resources 241 directly from the resource agent 242. Resources 241 may include but aren't limited to switched loads, HVAC loads, motors, and pumps. Resource agents 242 may also connect to other control systems 243 such as building control systems, chiller systems, and the like.

In a general sense FIG. 2 describes relationships and various interactions between resource agents 231, 242, and their consequent resources 270, 232, 233, 234, 235, 241, and 243. Through this mechanism, resources are under the top-level direction of the central processing platform 220 and local direction of the resource agents 231, 242, to enable phase independent and bidirectional real and reactive power flow on the utility power grid 260.

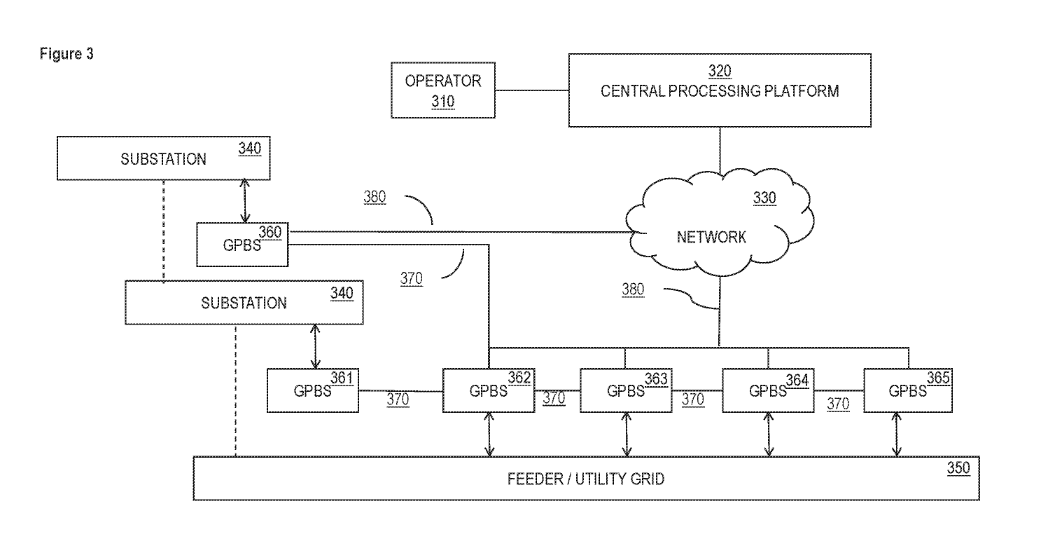

FIG. 3 is an illustration showing deployment locations of one or multiple grid power balancing systems 360-365 with contained resource agents on the hierarchical structure of connectivity for a typical electrical grid system 350. Many other network models exist and are also applicable to the claims, including one-to-one, one-to-many, many-to-many, and many-to-one network connections. Each substation node 340 may be connected to multiple feeders 350, and each feeder 350 may be connected to multiple consumer sites, loads, distributed energy resources, and resource agents contained within grid power balancing systems 360 with communication and processing capabilities. The location of each resource, electrical connection, or electrical network modeling point may be described as a “node” with many nodes comprised within an electrical connectivity model, one or many of which may have resources attached and controlled by GPBS 360. This construct may be typical but is not rigidly defined; each electrical grid may be defined by different connectivity or operating modes.

The resource agent contained in the GPBS 360 is a combination of communication and processor as a computer system, which may operate autonomously, in conjunction with other resource agents in a peer-to-peer network and as an integral part to the entire system, and typically provides for measurement and control of one or many resources. The resource agents may have two-way communications with a resource processor, to enable peer-to-peer 370 or peer-to-central processing platform 380 reporting on the state of the resources and to receive instructions to manage the resources. Control and initiation of a grid action is a combination of interactions between the central processing platform 320, GPBS 360, and an operator 340.

The geographical distribution of the resource agents 360 as well as their electrical relationship along the feeder 350 provides for management of the resources such that their associated data is flexible and efficient. Furthermore, precise control based upon geographically located resources or electrical connection, including the specifics of grid phase to a particular node is possible. Other control considerations such as performance, timeliness, and safety are used in determination of the specific combination of peer-peer versus centralized interactions for resource agents 360.

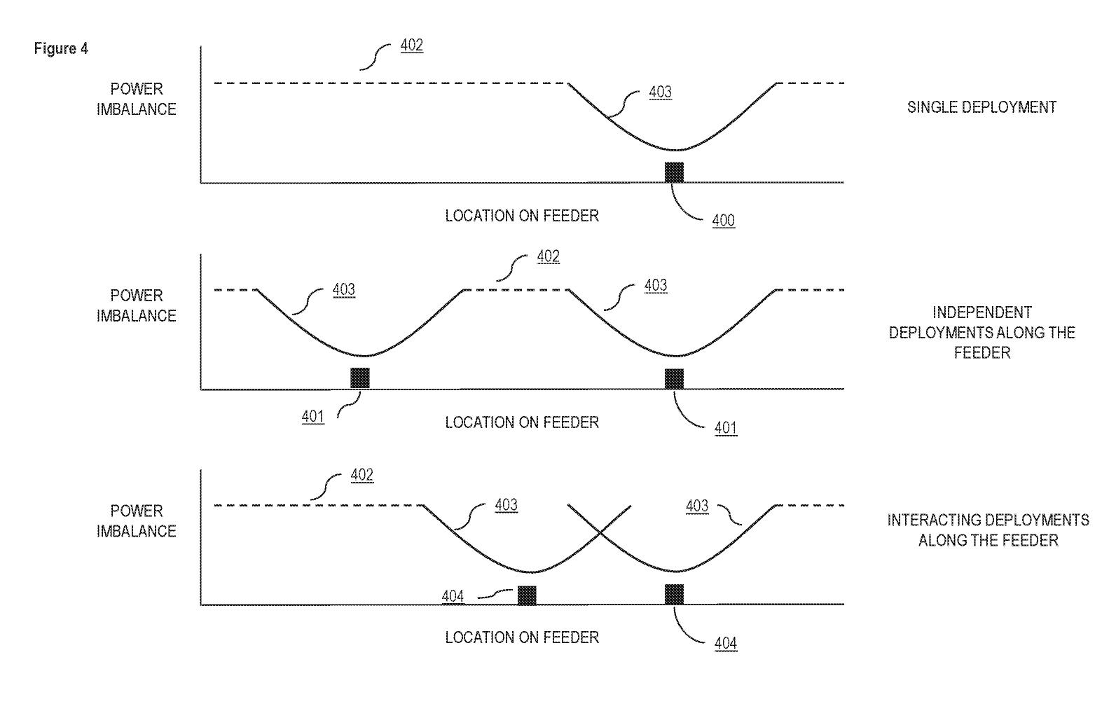

FIG. 4 demonstrates schematically the local impact 403 a deployment of a grid power balancing system 400 has on the power imbalance 402 on the grid. Multiple deployments 401 are considered independent if the proximity or electrical effects of their action on the power imbalance 403 is separate and non-interacting. Multiple deployments 404 are considered dependent where the proximity effects of their action on the power grid are interacting. Grid power balancing systems that are interacting are configured to work both autonomously and in a network via peer-to-peer communications. Instructions and operating configurations provided to each resource agent may include a list of interacting agents, their relative positions along the grid, their relative priorities, their available resources, and operating constraints.

In an example of use, a control unit 231 may deploy one or many of the sub-systems in one or many configurations determined to optimize the grid power balance on the feeder 260 either locally or in concert with interacting GPBS. Examples of some operating configurations either individually executed or in parallel, locally and in interactive deployments include but are not limited to the descriptions in the following sections.

The GPBS 230 manages power storage 232 charging and discharging on a schedule or determined by instruction. Charging of the storage 232 could in one instance be scheduled at night when variable power rates are low or when renewable generation resources are available. In one example during the day, real and reactive power can be routed back to the power grid 260 through the phase independent inverters 235, as offset generation during peak hours. An alternative configuration has the storage deliver power through the perfect power inverter 233 to the premises, providing reliable power and/or offsetting peak utility power grid 260 loads by reducing site consumption during peak. In another instance, the control unit 231 may request charging of the power storage 232 from the utility power grid 260 such to facilitate phase balancing by drawing real and reactive power at different rates and directions through the three independent phases of the phase independent inverters 235. Each of these configurations may be determined by schedule or by direct instruction from the control unit 231, which may be provided the central processing platform or through autonomous decision trees and process algorithms.

In one operation state, one of the phase independent power inverters 235 may be configured to draw power from the grid where all or some of the power is routed through the DC bus 234 and back through the other inverters onto the grid but on a different phase. Another operation state may have the power drawn through the phase independent inverters 235 at different rates per phase and routed through the DC power bus to the perfect power inverter 233, and then to the customer premises 244 as balanced three phase power. The previous are examples of how phase balancing can be achieved.

The phase independent power inverters 235 may be connected to a DC power bus 234 enabling the power drawn from the utility power grid 260 to be routed into storage 232, through the perfect power inverter 233 to the customer premises 244, or back through the phase independent power inverters 235 to resupply the grid with power. Configuration is dependent upon the resource agent 231, its decision algorithms, configuration and timely instructions received from the central process platform 220.

Perfect power may be delivered to a customer premises via the power inverter 233 to an extension of the GPBS 230 to 240. Through this power flow between GPBS control areas additional control elements can be incorporated into enabling desired grid level effects.

The resource agent 231 contained in the GPBS 230 may also control the operation and flow of power from external generation 270 sources. The resource agent 231 can route the power generation to the feeder/utility power grid 260, the customer premises 244 or to the storage system 232. The resource agent's 231 decision algorithms selects the destination from processing a plurality of input parameters such as local and global power balancing needs on the utility grid, time of day, power consumption demands, storage requirements and other inputs. Configuration changes and timely instructions from the central processing platform 220 may also affect the decision algorithms of the control unit 231.

In an instance of interacting GPBS's, the control units 231 act as a collection rather than autonomously. Peer-to-peer communication 370 is employed by the collection of GPBS's to optimize the global grid power 350. An example of peer-to-peer interaction includes but is not limited to the communication of a sequence of operations. In one instance, a GPBS deployment 363 interacting with GPBS 362 may communicate the status of its system as it nears or reaches a predetermined state. At this point, a message received by GPBS 362 from GPBS 363 may initiate a programmed operating configuration and further communicate with other GPBS units through peer-to-peer interactions to achieve the grid optimization objective. Overall, the central processing platform 320 manages action to achieve these same objectives.

In an instance of distributed deployments of non-interacting GPBS's, the central processing platform 320 receives the operating state of each sub-system, the participating premises and the grid power data. The central processing platform may identify the present operating state or predict future state 114 of sub-system operation based upon forecast 112 and resource and grid power models 110 and make decisions to alter the configuration at one GPBS 365 to alleviate conditions at another GPBS 361. For example, the phase independent inverter 235 on phase A of the utility grid 260 on GPBS 361 may be operating at the limits of its capacity and the central processing platform may call for timely dispatch at GPBS 365 to shed load on phase A, or alter load draw or generation on any other phase as determined to optimize operation.

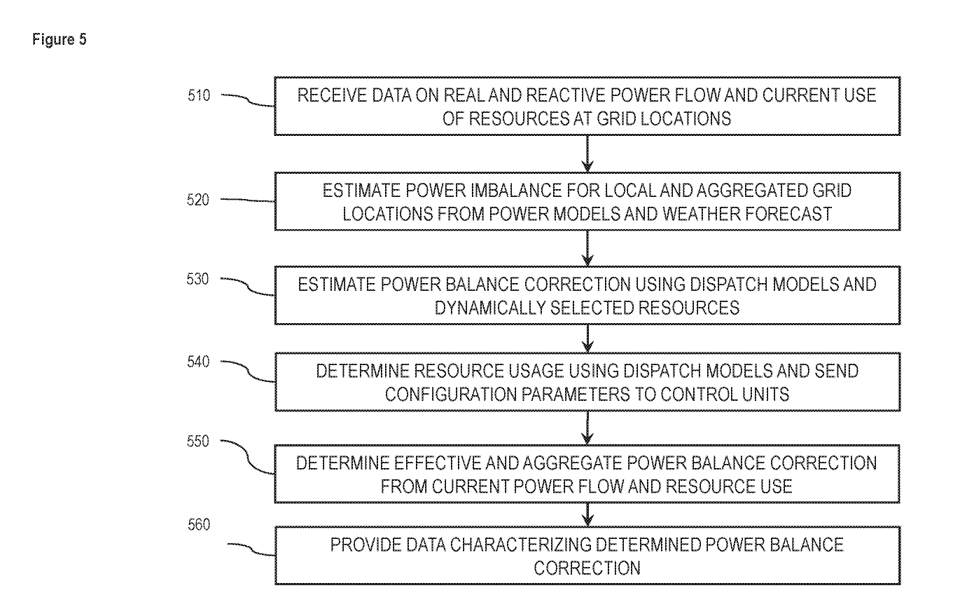

FIG. 5 is an example process flow diagram illustrating an automated method of determining grid power balancing actions and associated resource operating instructions. The system, using (i) power models, (ii) present operating state or resource use, and/or (iii) timely power sensing; estimates power imbalance local and globally across grid locations and affects grid power optimization through the dispatch of instructions and configurations to the deployed resources. The system receives at 510 real and reactive power flow data and present operating status or use of resources, and feeds that information along with determined grid power models, weather forecasts and power use forecasts to estimate power imbalance locally and globally on the grid 520. Resource dispatch models are employed 530 to determine the optimal impact on the grid power and to send the set of instructions and configurations to the deployed resources. Subsequent monitoring and data collection of the grid power and resource use is used to determine the effectiveness of the power balance correction dispatch 540. Data is collected describing resource participation, and grid power characterization and used to determine the effect on the power grid optimization 560. This data and event analysis is compared against power models and feeds back into the calculation of future models.

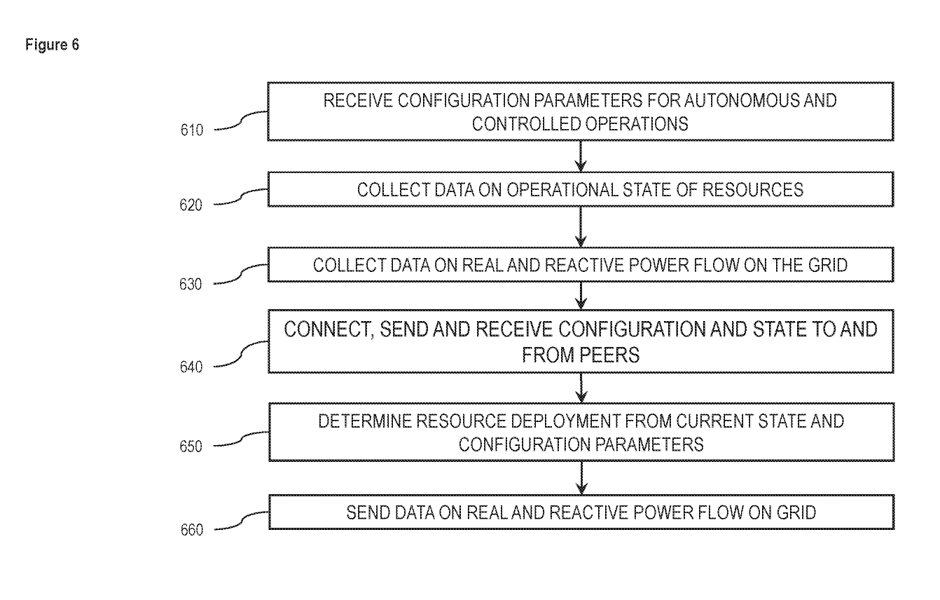

FIG. 6 illustrates the example process flow for resource agents acting within an interacting collection of resource agents based upon configuration parameters and peer to peer interaction. Each resource agent receives configuration parameters 610 that may include autonomous operating instructions and schedules and may also include a list of interacting resources along with their respective position, permissions, priority and operating constraints, including potential rules of arbitration for local decision processing. Operationally, each resource agent will collect data on the operational state of its resources 620 and sensing data 630. At predetermined intervals and connecting via peer to peer communications, each collection of interacting resource agents will connect, send and receive data on configurations, resource states and operational status 640. Each resource agent then determines its course of action which may be to continue operating without change to its resources or to implement a change in the operational parameters 650. Each resource agent independently communicates via the network to the central processing platform its present configuration, resource state and the real and reactive power flow on the grid 660.

Various implementations of the subject matter described herein may be realized in digital electronic circuitry, integrated circuitry, specially designed ASICs (Application Specific Integrated Circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The computing system may include processors which are able to operate autonomously or collaboratively based on their programing parameters and communication network to include a peer-to-peer relationship, communications and decision making between multiple peers independently or under the instruction of a client-server system.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

1. A method comprising:
receiving data comprising real and reactive power flow by phase and current use of resources at locations on a power grid;
estimating real and reactive power imbalances by phase for local power grid locations and aggregated power grid locations wherein the estimated power imbalances are based at least in part on at least one power model and a weather forecast;
estimating a power balance correction in total and by phase wherein the power balance correction is based at least in part on at least one dispatch model and at least one resource;
sending the power balance correction to a grid power balance system; and
adjusting at least one resource based on the power balance correction.

2. The method of claim 1 further comprising:
receiving subsequent data comprising real and reactive power flow by phase and current use of the resources at locations on a power grid; and
determining the effect of the power balance correction based at least in part on the subsequent data.

3. The method of claim 2 further comprising:
comparing the determined effect of the power balance correction to at least one power model; and
updating the at least one power model based at least in part on the comparison.

4. The method of claim 1 further comprising:
estimating the power imbalances for local power grid locations and aggregated power grid locations based additionally on a power use forecast.

5. A system comprising:
at least one data processor;
memory storing instructions which, when executed by a data processor, causes the data processor to perform operations comprising:
receiving data comprising real and reactive power flow by phase and current use of resources at locations on a power grid;
estimating power imbalances for local power grid locations and aggregated power grid locations wherein the estimated power imbalances are based at least in part on at least one power model and a weather forecast; and
estimating a power balance correction wherein the power balance correction is based at least in part on at least one dispatch model and at least one resource;
a communications processor for sending the power balance correction to a grid power balance system; and
at least one resource agent in communication with the grid power balance system and for adjusting at least one resource based on the power balance correction.

6. The system of claim 5 wherein the memory storing instructions which, when executed by a data processor, causes the data processor to perform operations further comprising:
receiving subsequent data comprising real and reactive power flow by phase and current use of the resources at locations on a power grid; and
determining the effect of the power balance correction based at least in part on the subsequent data.

7. The system of claim 6 wherein the memory storing instructions which, when executed by a data processor, causes the data processor to perform operations further comprising:
comparing the determined effect of the power balance correction to at least one power model; and
updating the at least one power model based at least in part on the comparison.

8. The system of claim 5 wherein the memory storing instructions which, when executed by a data processor, causes the data processor to perform operations further comprising further comprising:
estimating the power imbalances for local power grid locations and aggregated power grid locations based additionally on a power use by phase forecast.

9. A method comprising:
receiving at a resource agent at least one configuration parameter;
collecting data relating to the operational state of at least one resource;
sensing data relating to real and reactive power flow by phase on a power grid;
connecting with a peer-to-peer communications with at least one other resource agent;
sending the data relating to the operational state of the at least one resource to the at least one other resource agent;
receiving data from the at least one other resource agent the received data relating to the operational state of the at least one other resource in communication with the at least one other resource agent;
determining a resource deployment based at least in part on the configuration parameters, and the sent data relating to the operational state of the at least one resource and the received data relating to the operational state of the at least one other resource; and
sending information related to the determined resource deployment to central processing system.

10. The method of claim 9 wherein the at least one configuration parameter comprises at least one of: autonomous operating instructions, schedules, list of interacting resources, positions, permissions, priorities, operating constraints, or potential rules of arbitration.

11. The method of claim 9 wherein the step of connecting with a peer-to-peer communications is performed at predetermined intervals.
